(19) United States
(12) Patent Application Publication
(10) Pub. No.: US 2022/0261696 A1
(43) Pub. Date: Aug. 18, 2022

(54) RECOMMMENDER SYSTEM FOR ADAPTIVE COMPUTATION PIPELINES IN CYBER-MANUFACTURING COMPUTATIONAL SERVICES

(71) Applicant: VIRGINIA TECH INTELLECTUAL PROPERTIES, INC., Blacksburg, VA (US)

(72) Inventors: Ran Jin, Blacksburg, VA (US); Xiaoyu Chen, Blacksburg, VA (US)

(21) Appl. No.: 17/668,888

(22) Filed: Feb. 10, 2022

Related U.S. Application Data
(60) Provisional application No. 63/147,809, filed on Feb. 10, 2021.

(51) Int. Cl. G06N 20/20; G06N 3/08; G06K 9/62; G06F 16/951

(52) U.S. Cl. CPC G06N 20/20; G06N 3/08; G06F 16/951; G06K 9/6298; G06K 9/623; G06K 9/6247

(57) ABSTRACT

Various examples of recommender systems and methods for adaptive computation pipelines in cyber-manufacturing computational services are disclosed. An example method for recommending adaptive computation pipelines includes generating a covariates tensor, generating a sparse response matrix, completing a response matrix based on the covariates and sparse response matrix, determining a pipeline ranking, and generating a recommended pipeline.

### CROSS-REFERENCE TO RELATED APPLICATION

This application claims the benefit of and priority to U.S. Provisional Application No. 63/147,809, titled “RECOMMMENDER SYSTEM FOR ADAPTIVE COMPUTATION PIPELINES IN CYBER-MANUFACTURING COMPUTATIONAL SERVICES,” filed on Feb. 10, 2021, the entire contents of which are hereby incorporated herein by reference.

### BACKGROUND

Industrial cyber-physical systems can accelerate the transformation of offline data-driven modeling and statistical learning to online or real-time computation services, such as online prediction, monitoring, prognosis, diagnosis, and control. For the same type of computation services under different contexts, such as data sets and computation requirements, there are many different options of data analytics methods and algorithms.

### BRIEF DESCRIPTION OF THE DRAWINGS

Many aspects of the present disclosure can be better understood with reference to the following drawings. The components in the drawings are not necessarily drawn to scale, with emphasis instead being placed upon clearly illustrating the principles of the disclosure. In the drawings, like reference numerals designate corresponding parts throughout the several views.

FIG. 1 illustrates an example of a computing environment for a recommender system according to various embodiments described herein.

FIG. 2 illustrates an example of a recommender system in an environment of industrial internet for manufacturing with cloud and fog nodes according to various embodiments described herein.

FIG. 3 illustrates a diagram of example computation pipelines for modeling and prediction according to various embodiments described herein.

FIG. 4 illustrates an example overview of the recommender system according to various embodiments described herein.

FIGS. 5A-5C illustrate examples of ranked pipelines using the recommender system according to various embodiments described herein.

FIG. 6 illustrates an example of ranked pipelines under cold-start case according to various embodiments described herein.

FIGS. 7A-7C illustrate example computation pipelines ranked for 60 data sets according to various embodiments described herein.

FIG. 8 illustrates a flow chart of a method for recommending the top ranked pipelines according to various embodiments described herein.

FIG. 9 illustrates an example method for generating a recommended pipeline based on pipeline ranking according to various embodiments described herein.

### DETAILED DESCRIPTION

As noted above, industrial cyber-physical systems (ICPS) can accelerate the transformation of offline data-driven modeling to fast computation services, such as computation pipelines for prediction, monitoring, prognosis, diagnosis, and control in factories. However, it is computationally intensive to adapt computation pipelines to heterogeneous contexts in ICPS manufacturing. The recommender system for adaptive computation pipelines in cyber-manufacturing computational services disclosed herein ranks and selects the best computation pipelines to match contexts. The recommender system for adaptive computation pipelines, also referred to as AdaPipe herein, considers similarities of computation pipelines from word embedding, and features of contexts. Thus, without exploring all computation pipelines extensively in a trial-and-error manner, the recommender system for adaptive computation pipelines efficiently identifies top-ranked computation pipelines.

An ICPS interconnects many sensors, actuators, and manufacturing equipment into a network, and integrates ubiquitous computation resources, such as Fog and Cloud to support data-driven decision-making. The objective of ICPS in manufacturing is to improve efficiency and quality and control costs, while enabling the flexibility to meet highly personalized manufacturing product and service needs. In order to provide effective data driven decision-making supports, traditional offline data-driven modeling and statistical learning methods can be transformed to fast computation services for various objectives, such as fast quality modeling and prediction, monitoring, prognosis, and diagnosis in ICPS.

Computation services is a concept originated from large-scale computation, such as cloud computing and distributed computing. The objective of computation services is to provide computation capability and algorithms such as services to support data storage and analytics needs in various fields, such as cloud manufacturing, pervasive healthcare, large-scale deep learning, etc. Most of the mainstream computation services such as Apache Flink®, its extension in large scale production (Alibaba Blink), and a logic-based framework for analytic reasoning over streams (LARS) focus on providing the framework to support real-time computing.

Various embodiments for a recommender system for adaptive computation pipelines in cyber-manufacturing computational services are described herein. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a system to rank and recommend computational pipelines for different contexts. The system can include a computing device including at least one hardware processor. The system also includes program instructions executable in the computing device that, when executed by the computing device, cause the computing device to: generate a first set of covariate vectors based on a plurality of data sets, generate a second set of covariate vectors based on a plurality of pipelines, form a covariates tensor by determining an outer product of the first set of covariate vectors and the second set of covariate vectors, generate a sparse response matrix, wherein each row corresponds to a data set and each column corresponds to a pipeline, complete a response matrix based on the covariate tensor and the sparse response matrix, determine a pipeline ranking using the response matrix, and generate a recommended pipeline based on the pipeline ranking. Other embodiments of this aspect include corresponding computer systems, apparatus, and computer programs recorded on one or more computer storage devices, each configured to perform the actions of the methods.

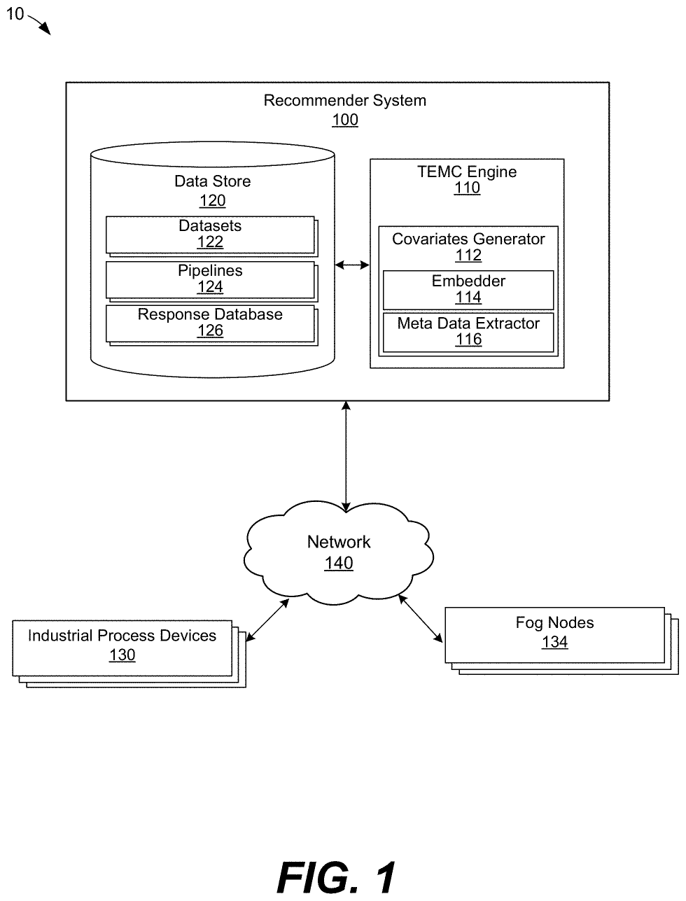

FIG. 1 illustrates an example of a computer environment 10 for a recommender system 100 for adaptive computation pipelines in cyber-manufacturing computational services. FIG. 1 is provided as a representative example. The computer environment 10 can include other components not shown, and the computer environment 10 can omit one or more of the components shown in some cases. In the example of FIG. 1, the computer environment 10 includes the recommender system 100, one or more industrial process devices 130, one or more fog modes 134, and a network 140.

The recommender system 100, also referred to herein as an AdaPipe recommender system or AdaPipe, can be embodied as one or more computers, computing devices, or computing systems. In certain embodiments, the recommender system 100 can include one or more computing devices arranged, for example, in one or more server or computer banks. The computing device or devices can be located at a single installation site or distributed among different geographical locations. The recommender system 100 can include a plurality of computing devices that together embody a hosted computing resource, a grid computing resource, or other distributed computing arrangement, managed as a software-defined data center (SDDC). Thus, the recommender system 100 can be embodied as an elastic computing resource where an allotted capacity of processing, network, storage, or other computing-related resources varies over time. As further described below, the recommender system 100 can also be embodied, in part, as certain functional or logical (e.g., computer readable instructions) elements or modules as described herein.

The recommender system 100 can operate as a computing environment for a recommender system for adaptive computation pipelines in cyber-manufacturing computational services. In some embodiments, the recommender system 100 can be included in a networked computing environment. In that context, the recommender system 100 includes a data store 120 and a tensor regression-based extended matrix completion (TEMC) engine 110. The covariates generator 112 includes an embedder 114, and a meta data extractor 116. The extractor 114, meta data extractor 116, and TEMC engine 110 can be embodied as applications executing on the recommender system 100. The TEMC engine 110, embedder 114, and meta data extractor 116 are described in further detail below.

The industrial process devices 130 can include software or applications to facilitate a user interface for direct access to the recommender system 100. In some embodiments, an industrial process device 130 can access the computing environment via a network 140. In some embodiments, one or more of the databases of the data store 120 can be located in a remote computing environment and accessed via the network 140. In some embodiments, the distributed devices 132 can access the computing environment via a network 140. For example, a distributed computing network or a “cloud” computing network can include a plurality of computers or servers for large-scale computation. In some embodiments, the recommender system 100 can include fog nodes 134 as a provided layer between industrial process devices 130 for one or more manufacturing processes. For example, an industrial process device can include one or more sensors, one or more actuators, manufacturing equipment, and the like. For example, manufacturing processes can include additive manufacturing processes, semiconductor manufacturing processes, printed electronic processes, and the like.

The data store 120 can be embodied as a memory device or medium to store data. The data store 120 can also include memory areas for the storage data sets 122, pipelines 124, and response databases 126, among other types of data. The data store 120 can store data in the form of relational databases, object-oriented databases, hierarchical databases, hash tables or similar key-value data stores, as well as other data structures. The data store 120 can include one or more databases stored locally or in a remote computing environment. For example, the data store 120 can reside in the recommender system 100. In an example, the pipelines 124 can be embedded or crowdsourced. The databases can include data sets 122 compiled by the user. For example, the pipelines 124 can be crowdsourced from one or more third-party devices. The data sets 122, pipelines 124, and response databases 126 are associated with the functional components and operations of the recommender system 100, as described below.

The recommender system 100 can generate a recommended pipeline based on the pipeline ranking. The covariates generator 112 includes an meta data extractor 116 and can generate a first set of covariate vectors based on a plurality of data sets 122. The embedder 114 can generate a second set of covariate vectors based on a plurality of pipelines 124. A covariates tensor can be formed by determining an outer product of the first set of covariate vectors and the second set of covariate vectors. A sparse response matrix can be generated from response performance data, wherein each row corresponds to a data set 122 and each column corresponds to a pipeline 124. The TEMC engine 110 can complete the response matrix based on the covariate tensor and the sparse response matrix. The pipelines 124 can be ranked using the response matrix and generate a recommended pipeline 124 based on the pipeline ranking. The ranked pipeline information can be saved in the response database 126.

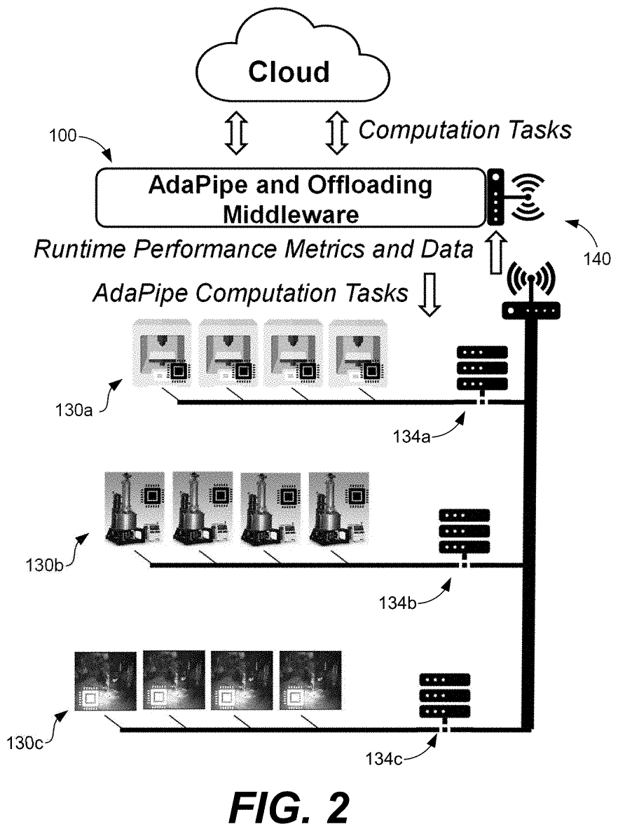

For example, shown in FIG. 2, is an environment of an industrial internet for manufacturing with cloud and fog nodes. The recommender system 100 can operate as a middleware for the industrial process devices 130 and fog nodes 134. The industrial processing devices 130 can include sensing and data-generating devices, as further described below. The fog nodes 134 can include one or more physical device computing units located with the industrial process devices 130. For example, fog nodes 134 can be implemented in hardware, software, or a combination of hardware and software, and can include one or more routers, switches, wireless access points, computers, and servers.

In the example shown in FIG. 2, the industrial process devices 130 can include equipment or devices for different industrial processes. For example, the industrial process devices can include devices for additive manufacturing processes 130a, semiconductor manufacturing processes 130b, and/or printed electronics processes 130c. Each fog node 134a-134c can be local to and correspond with each group or plurality of industrial process devices 130a-130c. For example, the fog nodes 134a-134c can collect runtime performance metrics and data to send to the recommender system 100 via network 140. The recommender system 100 can interface with a distributed computing network or cloud computing network for computation tasks. The recommender system 100 can send computational tasks and the recommended pipeline to the fog nodes 134 and industrial process devices 130.

In ICPS, the computation services must be accurate, reliable, responsive, and interoperable to be adaptive to heterogeneous manufacturing contexts. Thus, the recommender system for adaptive computation pipelines described herein defines contexts as the contextualized data sets, frequently changed manufacturing settings (e.g., replacement of manufacturing equipment, changed manufacturing recipe), and customized manufacturing and computation specifications. These frequently changed manufacturing contexts may cause suboptimal computation algorithms due to the violation of assumptions. These algorithms directly lead to inaccurate predictions, which may result in out-of-control systems and cause major manufacturing failures and irreparable loss.

For example, a violation of the independent and identically distributed (i.i.d.) assumption for modeling and prediction leads to high prediction error; and a violated assumption of underline distribution for a control chart in process monitoring may lead to high false alarm and mis-detection rate. Consequently, existing models and control charts can no longer be reliable. As another example, a selective laser melting (SLM) process requires high speed modeling algorithms to provide layer-to-layer quality prediction, which allows limited time to extensively explore all computation algorithms for prediction purpose. The time latency requirements may not be satisfied by a centralized algorithm.

For the same type of computation services in manufacturing, there are abundant choices of data analytical method options, such as data filtering and compression, dimension reduction, feature extraction, modeling methods, etc. Researches have been reported towards the objective of developing mathematical models based on sensor data to improve the quality and reliability of manufacturing processes since the 1970s. However, a typical paradigm for developing an effective data analytical method option is based on engineering knowledge for a specific manufacturing process and/or one's data-driven modeling experience, which requires a large number of trials. As a result, the inefficient trial-and-error studies prevent data analytics from being autonomous and responsive to be deployed in ICPS.

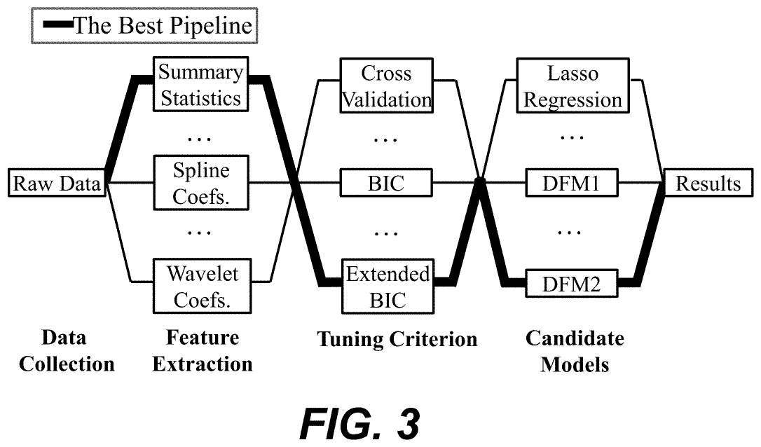

As a systematic way to explore existing data analytics method options, a computation pipeline (pipeline for brief) is considered as a sequence of method options from multiple steps. Turning to FIG. 3, illustrated are example computation pipelines for modeling and prediction with three steps (left to right) and three method options in each step. In this a non-limiting example, the three steps shown include: feature extraction, tuning criterion, and candidate models. The recommender system 100 can evaluate and rank pipelines based on those feature extraction, tuning criterion, and candidate models. However, the recommender system 100 can also be relied on to evaluate and rank pipelines for different sequences of steps with different method options in each step. To generalize, three steps are shown with three method options each in the example of FIG. 3, providing a total of 27 (i.e., 3×3×3) possible pipelines, with the best pipeline highlighted. As can be understood, depending on the computation service defined, the number of sequence steps and/or method options can be greater or smaller, resulting in a greater or smaller number of pipelines.

In the example pipeline shown in FIG. 3, the output from a method option in Step-i is directly used as the input for a method option in Step-(i+1). Here each Step is a collection of existing method options with the same functionality (e.g., feature extraction step as a collection of method options: summary statistics, spline coefficients, wavelet coefficients). By executing all candidate pipelines, the best pipeline associated with the lowest normalized root mean squared error (NRMSE) can be identified (i.e., shown as a bold line in FIG. 3). However, exploring all pipelines leads to a huge computation workload, while arbitrarily executing a few pipelines may not provide optimal performance. Thus, an efficient pipeline selection method is needed to minimize the optimal gap between the selected pipeline and the underline best pipeline.

Automated machine learning (AutoML) methods have been investigated aiming at automatically building machine learning applications without extensive knowledge of statistics and machine learning in the last decade. AutoML methods tackled the selection of machine learning methods (i.e., neural networks) in the format of computation pipelines or computation graphs from different perspectives. Most of the AutoML methods focus on automatic hyperparameter optimization to automatically select best hyperparameters for neural networks, and neural architecture search to automate the design of architecture. These methods promoted several commercial tools, such as Auto-WEKA, Auto-Sklearn, etc. However, the aforementioned methods adopt either greedy or random searching methods, hence requiring hours or even days to find a satisfactory computation pipeline.

Recently, collaborative filtering methods have been adopted to speed up the selection of computation pipelines for new data sets. In one example, OBOE (collaborative filtering for AutoML model selection) defined a matrix of cross-validated errors of supervised learning models and data sets, and proposed to complete the missing results for a new data set by using a time-constrained matrix completion model. OBOE is designed to start from test runs on several initial models on a new data set to convert a cold-start matrix completion problem to warm-start by filling in some entries for the empty row. It then sequentially executes models on the new data set based on design of experiment and update the completed matrix. However, directly providing a good computation model by predicting exact cross-validated errors may be biased by potential violation of the low-rank assumption for error matrix (e.g., the existence of outliers). Instead of sequentially predicting cross-validated errors, ranking the method options by pairwise comparisons can be more informative for users.

To overcome the aforementioned limitations, various examples of recommender systems and methods for adaptive computation pipelines in ICPS computation services are disclosed herein. The recommender system 100 formulates the selection of pipelines as a recommendation problem to rank and suggests the pipelines based on performance. The objective is to efficiently rank and recommend the best pipeline associated with the best performance (i.e., lowest prediction error) to be adaptive to frequently changing manufacturing contexts. Disclosed herein, the recommender system 100 defines a sparse response matrix, where each row and each column correspond to a data set and a pipeline (i.e., one path in FIG. 3 from data sourcing to models), respectively. And the (i,j)-th entry is defined as the statistical performance (e.g., prediction errors, time latency, etc.) of analyzing the i-th data set by using the j-th pipeline. This matrix is sparse in two scenarios, namely, (S1) arbitrarily missing entries: not all pipelines have been tested on one existing data set given limited time for trial-and-error modeling; and (S2) missing entire rows: a data set which is new to the recommender system 100 has not been analyzed on any pipelines. Here S1 is a typical assumption of matrix completion (MC) and matrix factorization. S2 is the well-known cold-start problem. Different from traditional MC methods, the recommender system 100 makes recommendations by quantifying not only the implicit similarity among entries in the sparse response matrix, but also the explicit similarity from covariates (i.e., dense representation of method options and meta data). Thus, the recommender system 100 can support computation services in an ICPS by efficiently providing accurate data analytics.

Different from Matrix Completion in collaborative filtering, the recommender system 100 makes a recommendation by quantifying not only the implicit similarity among entries in the sparse response matrix, but also the explicit similarity from covariates (i.e., dense representation of pipelines and meta data). Therefore, it contributes to current recommender systems in the following aspects: (1) the recommender system 100 uses unstructured descriptions to improve recommendation accuracy; (2) the recommender system 100 does not assume unknown entries to be arbitrarily missed; (3) the recommender system 100 does not require large samples size (i.e., number of entries in sparse response matrix), due to the existence of covariates and the l−1 penalization; and (4) the recommender system 100 is scalable when considering higher mode tensor covariates.

The recommender system 100 also contributes to computation services in ICPS by (1) adapting computation pipelines to ICPS contexts by efficiently suggesting the best computation pipelines; and (2) enabling the flexibility in customized performance metrics (e.g., prediction error, time latency, weighted combination, etc.) according to computation needs. Thus, the recommender system 100 can support computation services in ICPS by providing accurate and responsive data analytics.

The recommender system 100 differs from PRIME model (personalized recommendation for information visualization methods via extended matrix completion) in two aspects: (1) the recommender system 100 can adopt pairwise loss function for better ranking performance in a computation pipeline recommendation problem; and (2) the recommender system 100 pipelines generalizes PRIME by adopting covariates tensor, which contains more information than covariates that are in vector format since it introduces interaction between data sets and computation pipelines via an outer product.

In this context, various aspects of the recommender system 100 for adaptive computation pipelines in ICPS computation services are disclosed herein. Example case studies in thermal spray coating (TSC), Aerosol jet printing (AJP), and fused deposition modeling (FDM) processes are also described to validate the recommender system 100 for adaptive computation pipelines.

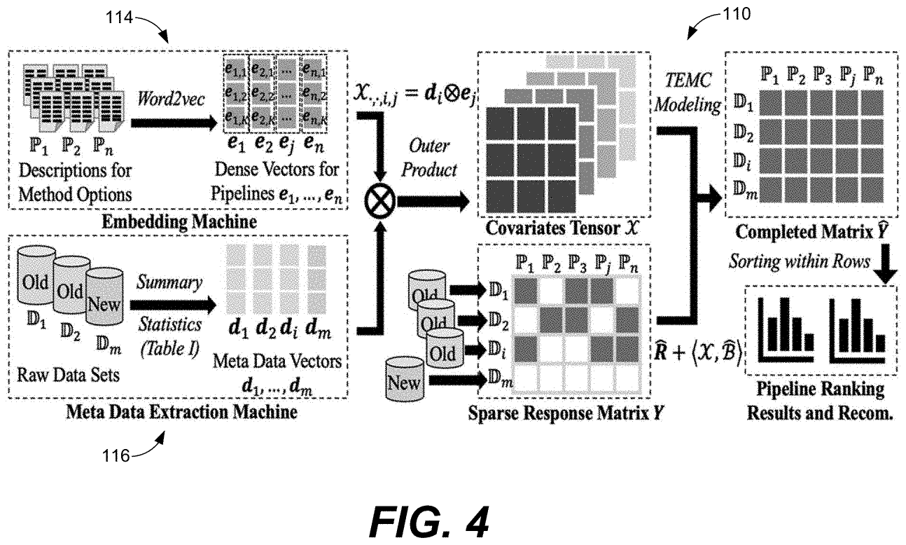

The recommender system for adaptive computation pipelines comprises a tensor regression-based extended matrix completion (TEMC) engine 110 and a covariates generator 112, including an embedder 114 and meta data extractor 116. As presented in FIG. 4, the recommender system 100 takes the vectorized pipelines 124 and meta data as input to generate covariates in a tensor format. The TEMC engine 110 then predicts missing entries based on both the sparse response matrix and the covariates. The pipelines 124 are then ranked and suggested according to the completed matrix. The TEMC engine 110 takes the covariates tensor and the sparse response matrix as input to complete the response matrix and further provides the ranking and recommendation of pipelines for both existing and new data sets. The recommender system for adaptive computation pipelines assumes that: the text descriptions for a method option and the comparison results with benchmarks are available; pipelines share the same steps for a certain type of computation services; and the sparse response matrix to be completed has a linear relationship with a low-rank matrix and covariates.

The TEMC engine 110 implements a tensor regression-based extended matrix completion (TEMC) model that can be described as follows. First, the notations are defined and summarized in Table 1. Here, meta data dᵢ is defined as a vector of summary statistics extracting from [symbol] ᵢ, where i=1,2, . . . , m; embedded vector e_{j,k} is extracted via word2vec for the method option in the j-th pipeline at the k-th step, where j=1,2, . . . , n, k=1,2, . . . , K, and dimension q is 50 in this example. Therefore, the j-th pipeline [symbol] ⱼ can be represented as an informative dense vector eⱼ in real space, by concatenating the method option vector in a pre-defined order of steps: eⱼ=concate(e_{j,1}, e_{j,2}, . . . , e_{j,K}). Based on these settings, the interaction (i.e., covariates) between the i-th data sets and the j-th pipelines is defined as the outer product of the i-th meta data vector dᵢ and the j-th pipeline vector eⱼ: [symbol] _{:,:,i,j}=dᵢ⊗eⱼ. Note that the covariates tensor X is not limited to four modes, other information related to the data set or pipeline can be incorporated as vectors in real space, which results in a larger number of modes for [symbol] . To formulate TEMC model, the (i,j)-th entry y_{i,j} is defined as the statistical performance for modeling the i-th data set by using the j-th pipeline. Hence, the TEMC model is proposed as Equation (1):

Y=R+ [symbol] [symbol] , [symbol] [symbol] +E, (1)

where low-rank matrix R represents the similarity among the statistical performances in Y; [symbol] = [symbol] ∈ [symbol] ^{m,n}, where c_{i,j}=Σₖ₌₁^{p}Σₗ₌₁^{qK} [symbol] _{k,l} [symbol] _{k,l,i,j}. In this way, the sparse response matrix Y is completed as Y by estimating R and [symbol] . The key idea of this model is to explain the similarities among the data sets and pipelines by decomposing Y into a low-rank matrix R to quantify the implicit similarity, and a tensor regression (TR) term [symbol] [symbol] B, [symbol] [symbol] to quantify the explicit similarity.

TABLE 1
Summary of notations

| Notations | Definitions |
|---|---|
| [symbol] | i-th raw data set |
| dᵢ | i-th meta data [symbol] ^{p} |
| m, n, K | m data sets, n pipelines, K steps |
| p | Dimension of summary statistics |
| [symbol] ⱼ | j-th pipeline |
| e_{j,k} | (j, k)-th embedded vector [symbol] ^{q} |
| q | Dimension of embedded vector |
| eⱼ | j-th embedded pipeline |
| X | Covariates tensor [symbol] ^{p×qK×m×n} |
| Y | Sparse response matrix [symbol] ^{m×n} |
| R | Low-rank matrix [symbol] ^{m×n} |
| [symbol] | Regression Coef. [symbol] ^{p×qk} |
| E | Error matrix [symbol] ^{m×n} |
| [symbol] _{Ω}(·) | Selector of non-empty entries |
| vec(·) | Vectorization operator |
| [symbol] ·,· [symbol] | Inner product in real space |
| ⊗ | Outer product dᵢ ⊗ eⱼ = dᵢeⱼ^{T} |
| λ₁, λ₂, s, t | Tuning parameters |
| ∥ · ∥_{*}, ∥ · ∥₁ | Nuclear norm and l-1 norm |
| [symbol] _{τ}(·) | Singular value soft-thresholding |
| [symbol] _{τ}(·) | Wavelet thresholding |

TEMC model is estimated by Problem (2):

min L(Ŷ,Y),s.t.∥R∥_{*}≤s,∥ [symbol] ∥₁≤t, (2)

where L(Ŷ,Y) is a loss function, such as least square loss, pairwise loss, etc.; nuclear norm ∥·∥_{*} is computed as ∥R∥_{*}=Σᵢ₌₁^{min(m,n)}σᵢ(R), where σᵢ(R) is the i-th singular value of R after performing singular value decomposition, to enforce low-rank structure of R; l−1 norm ∥·∥₁ is computed as ∥ [symbol] ∥₁=Σᵢ₌₁^{p}Σᵢ₌₁^{qK}| [symbol] _{i,j}| to control the sparsity of model coefficients [symbol] ; s≥0 and t≥0 are tuning parameters to control the amount of shrinkage, which can be selected by using cross validation. Specifically, if s becomes larger, implicit similarity can be smaller; and if t becomes larger, more covariates can be selected as significant factors.

In this example, the form of the loss function L(Ŷ, Y) in consideration of accurately ranking pipelines { [symbol] ᵢ} is further investigated for each data set. Pairwise loss function was reported to be used for the learning-to-rank problem in information retrieval communities. Therefore, pairwise loss (see Function (3)) was adopted in the estimator to both consider pairwise comparison for higher ranking accuracy, which can be compared with least square loss.

$${min}_{\hat{ℬ} , \hat{R}} {\sum }_{i = 1}^{m} \frac{1}{\vert {Ω}_{i} \vert} {\sum }_{u ∈ {Ω}_{i}} {\sum }_{v ∈ {Ω}_{i}} {[ ( {y}_{i , u} - {y}_{i , v} ) - ( {\hat{y}}_{i , u} - {\hat{y}}_{i , v} ) ]}^{2} , \qquad ( 3 )$$

where Ωᵢ is the index set of non-empty entries in the i-th row of sparse response matrix Y to standardize the pairwise loss for the i-th data set; and |·| is the cardinality of a set. Adopting pairwise loss provides the users with more informative recommendation results by ranking computation pipelines, especially when comparing with collaborative filtering methods that aimed at predicting exact cross-validated errors for methods.

To derive an efficient algorithm, it is shown that a pairwise loss function is equivalent to a quadratic matrix form in Proposition 1. Therefore, close form solutions can be derived for the sub-problems, described in further detail herein.

Proposition 1. Function (3) is equivalent to a quadratic matrix form which is convex:

$${[ vec ( Y - \hat{Y} ) ]}^{T} 𝕃 [ vec ( Y - \hat{Y} ) ] , given 𝕃 = [ \begin{matrix}\frac{1}{\vert {Ω}_{1} \vert} L & … & 0 \\ ⋮ & ⋱ & ⋮ \\ 0 & … & \frac{1}{\vert {Ω}_{m} \vert} L\end{matrix} ] , \\ {L}_{u , v} = \{ \begin{matrix}\vert {Ω}_{1} \vert - 1 , & if u = v \\ - 1 , & otherwise\end{matrix}$$

Motivated by alternating direction method of multipliers (ADMM), the augmented Lagrangian function is given by:

$$ℒ ( R , ℬ , C , 𝒟 , U , 𝒱 ) = \frac{{μ}_{1}}{2} {‖ R - C ‖}_{F}^{2} + \frac{{μ}_{2}}{2} {‖ ℬ - 𝒟 ‖}_{F}^{2} + {[ vec ( {𝒫}_{Ω} ( Y ) - {𝒫}_{Ω} ( \hat{Y} ) ) ]}^{T} 𝕃 [ vec ( {𝒫}_{Ω} ( Y ) - {𝒫}_{Ω} ( \hat{Y} ) ) ] + {λ}_{1} {‖ C ‖}_{*} + {λ}_{2} {‖ 𝒟 ‖}_{1} + 〈 U , R - C 〉 + 〈 𝒱 , ℬ - 𝒟 〉 ,$$

where C=R and [symbol] = [symbol] are two linear constraints associated with two dual variables U and V, respectively; λ₁≥0 and λ₂≥0 are the tuning parameters for ∥C∥ and ∥ [symbol] D∥₁, respectively; μ₁>0 and μ₂>0 are two parameters which influence the convergence speed; and the term

$$\frac{{μ}_{1}}{2} {‖ R - C ‖}_{F}^{2}$$

and term

$$\frac{{μ}_{2}}{2} {‖ ℬ - 𝒟 ‖}_{F}^{2}$$

penalize violations of the aforementioned linear constraints. The ADMM method is investigated to decouple the non-differentiable terms by alternating among the minimization sub-problems as shown in Problem (4):

$${R}^{k + 1} := {min}_{R} L + 〈 {U}^{k} , R - {C}^{k} 〉 + \frac{{μ}_{1}}{2} {‖ R - {C}^{k} ‖}_{F}^{2} , \\ {ℬ}^{k + 1} := {min}_{ℬ} L + 〈 {𝒱}^{k} , ℬ - {𝒟}^{k} 〉 + \frac{{μ}_{2}}{2} {‖ ℬ - {𝒟}^{k} ‖}_{F}^{2} , \\ {C}^{k + 1} := {min}_{C} {λ}_{1} {‖ C ‖}_{*} + 〈 {U}^{k} , {R}^{k + 1} - C 〉 + \frac{{μ}_{1}}{2} {‖ {R}^{k + 1} - C ‖}_{F}^{2} , \\ {𝒟}^{k + 1} := {min}_{D} {λ}_{2} {‖ 𝒟 ‖}_{1} + 〈 {𝒱}^{k} , {ℬ}^{k + 1} - 𝒟 〉 + \frac{{μ}_{2}}{2} {‖ {ℬ}^{k + 1} - 𝒟 ‖}_{F}^{2} , \\ {U}^{k + 1} = {U}^{k} + {μ}_{1} ( {R}^{k + 1} - {C}^{k + 1} ) , \\ {𝒱}^{k + 1} = {𝒱}^{k} + {μ}_{2} ( {ℬ}^{k + 1} - {𝒟}^{k + 1} ) , \\ where L = {[ vec ( {𝒫}_{Ω} ( Y ) - {𝒫}_{Ω} ( \hat{Y} ) ) ]}^{T} 𝕃 [ vec ( {𝒫}_{Ω} ( Y ) - {𝒫}_{Ω} ( \hat{Y} ) ) ] , \\ and k is the index of iteration . \qquad ( 4 )$$

Denote x=vec(X), y=vec(Y), r=vec(R), b=vec( [symbol] ), v=vec(V), and the subscript (·)_{Ω} as the selector to only contain the element according to the index of the non-empty entries in Y. Denote [symbol] _{T}(·) as the singular value soft-thresholding operator. Denote a singular value decomposition (SVD) of matrix C∈ [symbol] ^{m×x} as C=AΣB*, where Σ=diag({σᵢ}_{1≤i≤r}). Then [symbol] _{T}(C)=diag({(σᵢ−τ)₊}_{1≤i≤r}), where (σᵢ−τ)₊=max(0,σᵢ−τ). As another soft-thresholding operator in Algorithm 1, [symbol] (·) was introduced as wavelet thresholding. It can be defined as [symbol] (w)=[t_{λ}(w₁), t_{λ}(w₂), . . . ]^{T}, where t_{λ}(wᵢ)=sgn(wᵢ){(wᵢ−λ)₊}.

The pseudo code for the proposed algorithm is summarized in Algorithm 1. This algorithm is guaranteed to converge based on Theorem 1 with a unique solution.

Algorithm 1 Solver for TEMC

```
Initialize R⁰, [symbol] ⁰, C⁰, [symbol] ⁰, U⁰, and V⁰.
repeat
  r^{k+1} = (2 [symbol]   + μ₁I)⁻¹(μ₁c^{k} − u^{k} + 2 [symbol]  y − 2 [symbol]  vec(( [symbol] , X))),
  then reshape to R^{k+1},
  ${β}^{k + 1} = {( {x}_{Ω}^{T} {L}_{Ω} {x}_{Ω} + \frac{{μ}_{1}}{2} {I}_{Ω} )}^{- 1} [ \frac{1}{2} ( {μ}_{2} {d}^{k} - {v}^{k} ) + {x}_{Ω}^{T} {L}_{Ω} ( {y}_{Ω} - {r}_{Ω}^{k + 1} ) ] ,$
  then reshape to [symbol] ^{k+1},
  ${C}^{k + 1} = {𝒮}_{\frac{{λ}_{1}}{{μ}_{2}}} ( {R}^{k + 1} + \frac{{U}^{k}}{{μ}_{1}} ) ,$
  ${d}^{k + 1} = {𝒯}_{\frac{{λ}_{2}}{{μ}_{2}}} ( {β}^{k + 1} + \frac{{v}^{k}}{{μ}_{2}} ) , then reshape to {𝒟}^{k + 1} ,$
  U^{k+1} = U^{k} + μ₁(R^{k+1} − C^{k+1}),
  V^{k+1} = V^{k} + μ₂( [symbol] ^{k+1} − [symbol] ^{k+1}),
until
$Convergence : \frac{[ {L}^{k + 1} - {L}^{k} ]}{[ {L}^{k} ]} \leq tol .$
```

Theorem 1. Suppose at least one optimal solution for Algorithm 1 exists and is defined as (R*, [symbol] *, C*, [symbol] , U*, and V*). Under the conditions that λ₁≥0, λ₂≥0, μ₁>0, μ₂>0, the following convergence property holds:

$${lim}_{k \to ∞} L ( Y , {\hat{Y}}^{k} ) + {λ}_{1} {‖ {R}^{k} ‖}_{*} + {λ}_{2} {‖ {ℬ}^{k} ‖}_{1} = L ( Y , {\hat{Y}}^{*} ) + {λ}_{1} {‖ {R}^{*} ‖}_{*} + {λ}_{2} {‖ {ℬ}^{*} ‖}_{1} ,$$

solution is unique.

An example of the covariates generator 112 of the recommender system is shown in FIG. 4. The covariates generator 112 comprises an embedder 114, shown as embedding machine, for pipeline embedding, and the meta data extractor 116, shown as meta data extraction machine, to generate meta data vectors from existing and new data sets. In this example, the embedding machine includes a web crawler and a word2vec embedding neural network. Descriptions of method options in computation pipelines are determined and the method options embedded as dense vectors in real space with a certain length. The meta data extraction machine receives raw data sets and generates a vector of summary statistics from a data set according to predefined summary statistic operator lists. The vectorized pipelines and meta data are used as input to generate covariates in a tensor format. The generated covariates can be used for model estimation by using Algorithm 1. The TEMC model then predicts missing entries based on both the sparse response matrix and the covariates. In the end, the pipelines are ranked and suggested according to the completed matrix.

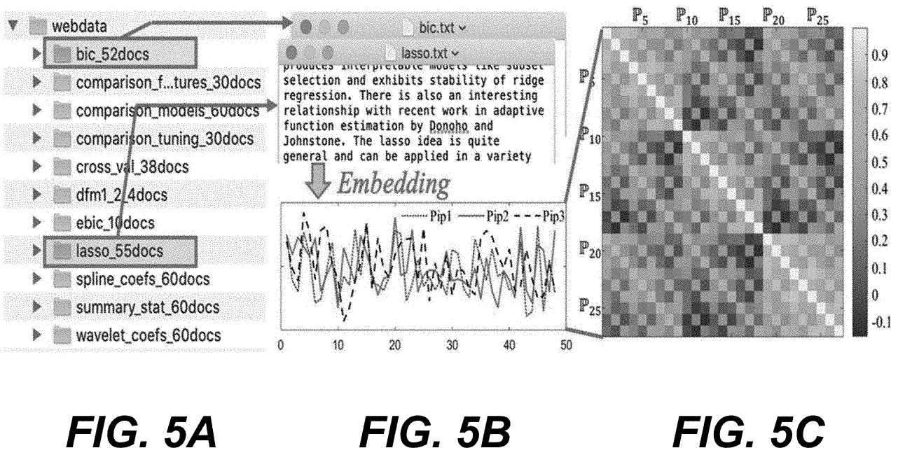

Shown in FIGS. 5A-5C is an illustration of prepared descriptions for method options. FIG. 5A presents the structure of scraped corpus as input for an embedding machine, including descriptions (i.e., text documents parsed from scraped HTML and PDF files, e.g., see examples in FIG. 5A-top) of each method option in computation pipelines, and comparison studies among method options in the same step. In FIG. 5B-bottom, shown is a graph to visualize the embedded pipeline vectors for three pipelines. In FIG. 5C, the example visualizes the cosine similarities among embedded pipelines for 27 computation pipelines.

The embedding machine can include a web crawler and a word2vec embedding neural network, for example, provided by Gensim coded in Python program language. The web crawler collects and parses websites and documents as a corpus of text documents, which includes detailed descriptions of and comparisons among different method options in computation pipelines (see structure of the corpus in FIG. 5A, and examples of extracted documents in FIG. 5B). Afterwards, this corpus can serve as the input to a word2vec neural network to embed the method options as dense vectors in real space with a certain length (i.e., 16 in this example). The embedded vectors should be informative to quantify the similarity and dissimilarity among method options within one step in pipelines. Thus, the vector representation of a pipeline eⱼ can be generated by concatenating the vectors of corresponding method options in the same order as they form the pipeline (i.e., a 16×3=48-dimensional vector). A visualization of cosine similarity among the embedded vector representations of all 27 computation pipelines is shown in FIG. 5C.

The meta data extraction machine can generate a vector of summary statistics from a data set according to predefined summary statistic operator lists. For the recommender system for adaptive computation pipelines, without loss of generality, a data set in an ICPS can be categorized into three subset of variables: (1) process setting variables, (2) in situ process variables, and (3) response variables. Three summary statistic operator lists for three variable categories are reported in Table 2. Therefore, the meta data vector dᵢ for a data set can be generated by concatenating three vectors extracted from three variable categories.

TABLE 2
Summary statistic operator lists

| Process Setting Vars. | in situ Process Vars. | Response Vars. |
|---|---|---|
| Number of rows | Number of rows | Mean value |
| Number of columns | Number of columns | Std. value |
| Mean of mean values | Mean of mean values | Range |
| Std. of mean values | Std. of mean values | Kurtosis |
| Mean of Kurtosis | Mean of Kurtosis | Skewness |
| Mean of Skewness | Mean of Skewness | |

An outer product can then be used to generate the informative interactions between data sets and pipelines (i.e., covariates) as [symbol] _{:,:,i,j}=dᵢ⊗eⱼ∈ [symbol] ^{p×qK×m×n}, for i=1,2, . . . , m, and j=1,2, . . . , n. Note that the information for covariates is not limited to the pipeline embeddings and the meta data from data sets, other related information can also be vectorized in real space and serve as new modes for the covariates tensor [symbol] .

In an example real case study, six initial data sets were extracted from TSC, AJP, and FDM processes as summarized in Table 3, where map sets identify the variable relationships among process setting variables and in situ process variables. The map sets are necessary for several data fusion-based method options included in the pipelines. Here, a process setting variable is defined as a scalar value which sets a condition for a process (e.g., temperature setting for furnace); and an in situ process variable is collected during the process by sensor system in a time series format. Two types of changing manufacturing contexts can be identified in Table 3: (1) Data Sets 1-4 represent the changing of quality management plans with the same process variables but different response variables; and (2) Data Sets 1, 5, and 6 represent the changing of processes with totally different process and response variables, which identify the differences among six manufacturing data sets. To stress the recommender system for adaptive computation pipelines, bootstrapping by re-sampling to increase the number of data sets was applied. As a result, ten new data sets are bootstrapped with 90% observations from each data set in Table 3. Thus, in total 60 data sets are generated. Meta data dᵢ∈ [symbol] ¹⁷, where i=1, . . . , 60 are extracted from these 60 data sets via the 17 summary statistic operators in Table 2.

TABLE 3
Summary of six manufacturing data sets

| | | | |
|---|---|---|---|
| Data | Resp. | Vars. | Map |

| Sets | Process Vars. (Types) | (Obs) | Sets |
|---|---|---|---|
| 1 | 1) Stand-off distance (Setting) | Porosity(40) | 1-13 |
| | 2) Surface speed (Setting) | | |
| | 3) Current of the torch (Setting) | | |
| | 4) Primary gas flow rate (Setting) | | |
| | 5) Secondary gas flow rate (Setting) | | |
| 2 | 6) Carrier gas flow rate (Setting) | Roughness(40) | 1-14 |
| | 7) Traverse rate (Setting) | | 1-15 |
| | 8) Particle velocity (in situ) | | 2-21 |
| | 9) Particle temperature (in situ) | | 3-11 |
| | 10) Correlation (in situ) | | 3-12 |
| 3 | 11) Head temperature (in situ) | Curvature(40) | 3-16 |
| | 12) Plume temperature (in situ) | | 3-20 |
| | 13) Total intensity (in situ) | | 3-21 |
| | 14) Peak intensity (in situ) | | 4-19 |
| | 15) Half width (in situ) | | 5-19 |
| 4 | 16) Substrate temperature (in situ) | Depo-rate(40) | 6-19 |
| | 17) Laser displacement (in situ) | | |
| | 18) Arc current (in situ) | | |
| | 19) Gas flow rate 1&2 (in situ) | | |
| | 20) Arc voltage (in situ) | | |
| | 21) Surface temperature (in situ) | | |
| 5 | 1) Process speed (Setting) | Resistance(90) | 1-5 |
| | 2) Atomizer gas flow rate (Setting) | | 1-6 |
| | 3) Shealth gas flow rate (Setting) | | 2-5 |
| | 4) Atomizer power voltage (Setting) | | 3-5 |
| | 5) Current (in situ) | | 4-5 |
| | 6) Nozzle location - x, y (in situ) | | |
| 6 | 1) Nozzle travel speed (Setting) | Surf-Rough.(48) | |
| | 2) Nozzle temperature (Setting) | | 1-3 |
| | 3) Vibration signals | | 1-4 |
| | (on the nozzle) - x, y, z | | |
| | (in situ) | | |
| | 4) Vibration signals (on the bed) - | | 2-5 |
| | x, y, z (in situ) | | |
| | 5) Nozzle temperature (in situ) | | 2-6 |
| | 6) Bed temperature (three sensors | | |
| | on the bed) (in situ) | | |

In this example, the pipelines (see FIG. 3) model the aforementioned 60 data sets, where data fusion model 1 (DFM1), and DFM2 were recently proposed. FIG. 3 presents in total 27 (i.e., 3×3×3) candidate pipelines. Based on 60 bootstrapped data sets and 27 pipelines, the sparse response matrix Y∈ [symbol] ^{60×27} can be extracted in two sets of cases, i.e., warm-start and cold-start, to compare the statistical performance of the recommender system for adaptive computation pipelines (AdaPipe) with three benchmark models: Matrix Completion, Tensor Regression, and PRIME models. PRIME model and estimator are introduced in Model (5).

$$\begin{matrix}Model : & & Y = R + 𝒜 ( X β ) + E , \\ Estimator : & {minimize}_{R , β} & {‖ Y - R - 𝒜 ( X β ) ‖}_{F}^{2} \\ & subject to & {‖ R ‖}_{*} \leq s , {‖ β ‖}_{1} \leq t ,\end{matrix} \qquad ( 5 )$$

where a least a square loss function was applied for point estimation with a nuclear norm and a l−1 norm penalization. Since this model takes covariates matrix X as input instead of the covariates tensor [symbol] , the covariates are redefined as X_{h,:}=concat(dᵢ,eⱼ)∈ [symbol] ^{p+qK} where h=m(i−1)+j and h∈{1,2, . . . , mn}.

TABLE 4
Average values and standard errors (within parenthesis) of AdaPipe
recommender system and three benchmark models evaluated on 60
bootstrapped data sets and 27 computation pipelines. The significantly
best performance is highlighted in bold.

| | | Warm-start | | | | | |
|---|---|---|---|---|---|---|---|
| Tol. T | Methods | ρ = 0.9 | ρ = 0.7 | ρ = 0.5 | ρ = 0.3 | ρ = 0.1 | Cold-start |
| 0% | Matrix Completion | 12.367 | 11.017 | 10.767 | 12.800 | 11.467 | 12.400 |
| | | (1.363) | (1.481) | (1.536) | (1.415) | (1.587) | (1.311) |
| | Tensor Regression | 12.017 | 11.300 | 10.100 | 8.317 | 8.467 | 10.033 |
| | | (1.488) | (1.348) | (1.466) | (1.282) | (1.240) | (1.398) |
| | PRIME | 9.833 | 8.583 | 8.267 | 6.283 | 6.233 | 8.150 |
| | | (1.217) | (1.204) | (1.021) | (0.856) | (0.948) | (1.198) |
| | AdaPipe | 8.733 | 8.367 | 7.917 | 5.483 | 2.900 | 8.983 |
| | | (1.333) | (1.364) | (1.295) | (1.180) | (0.765) | (1.327) |
| 10% | Matrix Completion | 7.033 | 6.267 | 6.450 | 8.083 | 6.867 | 8.800 |
| | | (1.050) | (1.224) | (1.292) | (1.182) | (1.266) | (1.258) |
| | Tensor Regression | 5.650 | 6.800 | 6.983 | 5.617 | 5.700 | 7.183 |
| | | (0.938) | (1.035) | (1.176) | (0.912) | (0.880) | (1.110) |
| | PRIME | 5.000 | 5.600 | 5.233 | 3.667 | 3.017 | 4.683 |
| | | (0.963) | (1.009) | (0.888) | (0.582) | (0.737) | (0.860) |
| | AdaPipe | 4.917 | 3.867 | 3.833 | 2.183 | 1.650 | 4.533 |
| | | (0.890) | (0.935) | (0.866) | (0.633) | (0.368) | (0.861) |

In warm-start cases, Y is extracted under the assumption of arbitrarily missing entries with five levels of missing rates ρ_{f}∈{0.1,0.3,0.5,0.7,0.9}, f=1, . . . 5, by setting arbitrarily selected ρ_{f}×mn entries in Y to be 0. For cold-start cases, Y is extracted under the assumption of missing an entire row (i.e., a new data set has not been modeled by any pipeline) by setting a row of entries to be 0 in Y. Therefore, in total five warm-start cases and a cold-start case are extracted.

Since the objective of the recommender system for adaptive computation pipelines is to rank and recommend the pipelines for data sets, using the minimal number of top-ranked pipelines to reach the best statistical accuracy (i.e., NRMSE in this research) for the i-th data set with a tolerance level T in percentage (AMᵢ(T)) as the performance metric. Assuming y_{i,j*} to be the optimal NRMSE for pipelines on the i-th data set, AML(T) can be shown as

$${AM}_{i} ( T ) = {min}_{j ∈ \{ 1 , … , 27 \}} \vert ( 1 + T ) {y}_{i , {j}^{*}} - {y}_{i , j} \vert .$$

For example, AM₁(0%)=5 indicates that executing the top-5 ranked pipelines is adequate to reach the lowest NRMSE; and AM₁(10%)=3 indicates that executing the top-3 ranked pipelines is adequate to achieve a satisfactory NRMSE which is 10% greater than the lowest possible NRMSE.

The TEMC model is simultaneously estimated and used for prediction since it is an unsupervised learning method. Two 10-fold cross-validation (CV) was implemented to select the tuning parameters λ₁ and λ₂ for the proposed model. For model evaluation, different training-testing splitting strategies were used for warm-start and cold-start scenarios. Namely, for warm-start scenarios, (1−ρ_{f})mn training samples were arbitrarily selected from the entries in sparse response matrix Y, and the remaining entries are treated as testing samples. Besides, ten replicates were conducted with different testing samples for each missing rate ρ_{f} ∈{0.1,0.3,0.5,0.7,0.9}. For cold-start scenarios, 60-fold leave-one-data-set-out cross-validation was adopted to select the training and testing samples. Specifically, entries in 59 out of 60 rows in Y were selected as training samples, and the entries in the remaining one row were selected as testing samples. This procedure was repeated for 60 times to ensure that every row in Y can be selected as testing samples in one cross-validation fold. The recommendation results are compared with three benchmark models in the same sets of cases.

The average values and standard errors of the performance metric AMᵢ(T) over CV folds is summarized in Table 4, where the best performance (i.e., the lowest mean values and the lowest standard errors) are highlighted in bold. It can be concluded that the recommender system for adaptive computation pipelines outperforms three benchmark models by executing the lowest number of pipelines to achieve the underline best performance. For tolerance level T=0% under the worst cases (i.e., warm-start case when missing rate ρ=0.9, and cold-start case), the recommender system for adaptive computation pipelines saves

$$1 - \frac{8.733}{27} = 67.66 \% and 1 - \frac{8.983}{27} = 66.73 \%$$

computation workloads. And the recommender system for adaptive computation pipelines saves

$$1 - \frac{4.917}{27} = 81.79 \% and 1 - \frac{4.533}{27} = 83.21 \%$$

computation workloads for tolerance level T=10%. It can be observed that the ranking performances of the recommender system for adaptive computation pipelines in warm-start scenarios with ρ∈{0.1,0.3,0.5,0.7}outperform those in cold-start scenarios. The reason is that relatively lower sparsity in Y can support better estimation of the low-rank structure, which directly leads to higher ranking accuracy. However, the ranking performances of the recommender system for adaptive computation pipelines in warm-start scenarios when ρ=0.9 are worse than those in cold-start scenarios, since only the execution results for, on average, (1−0.9)×27=2.7 computation pipelines are available in each data set. As a result, the low-rank structure in Y is hard to be accurately estimated when compared with the estimation in cold-start scenarios.

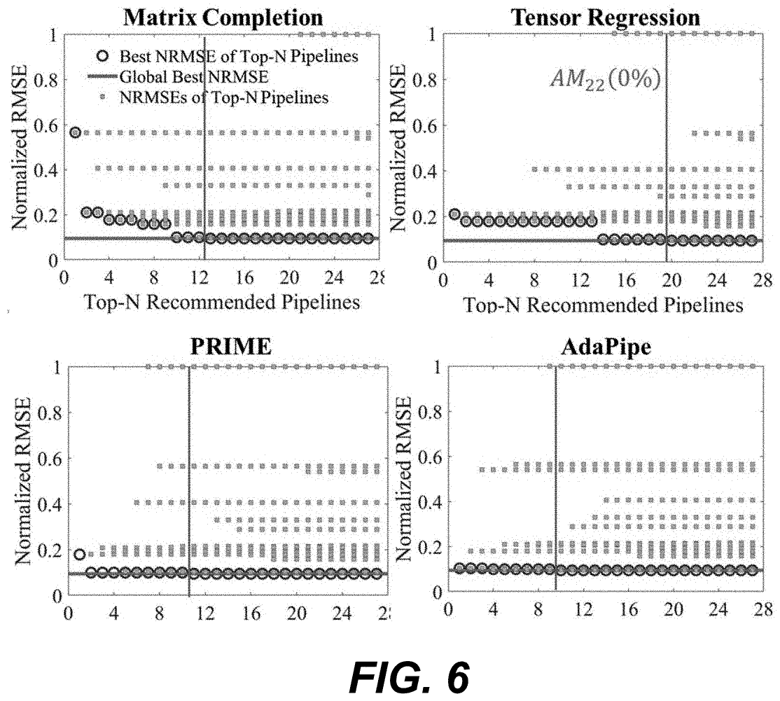

FIG. 6 illustrates an example of ranked pipelines under a cold-start case according to various embodiments described herein. FIG. 6 includes examples of ranked computation pipelines for comparing results of the AdaPipe recommender system and three benchmark models, including Matrix Completion, Tensor Regression, and PRIME. An example of ranked pipelines under cold-start case for the 22-th data set is shown. The circles identify the lowest NRMSE among Top-N recommended pipelines; the horizontal line is the global lowest NRMSE among all 27 pipelines; and the squares show the NRMSEs for Top-N recommended pipelines; and the vertical line shows the performance metric AM₂₂(0%).

It can be observed from FIG. 6 that (1) the Top-1 recommended computation pipeline by the recommender system for adaptive computation pipelines has the closest NRMSE to the global best NRMSE; (2) the recommender system for adaptive computation pipelines yields the lowest AM₂₂(0%) among four models; and (3) the recommender system for adaptive computation pipelines presents the best ranking performance by investigating the trends and distribution of the dots.

When comparing performance among benchmark models, the matrix completion does not perform well under both warm-start and cold-start cases due to the limited sample size, which results in full rank Y. Tensor regression significantly outperforms the matrix completion method since it does not require a large sample size, and it quantifies the information contained in the covariates. However, better ranking and recommendation performance of PRIME model indicates that the implicit similarity existed in the low-rank matrix R decomposed from Y can significantly improve the ranking and recommendation performance. Therefore, the best ranking and recommendation performance provided by the recommender system for adaptive computation pipelines may be attributed to the following reasons: (1) pairwise loss function provides the capability to rank the computation pipelines by comparing statistical prediction errors in pairs, but ignoring the alignment between predicted responses and true responses; (2) low-rank matrix R and covariates X effectively quantify the implicit and explicit similarities, which jointly contributes to accurate ranking and recommendation performance; and (3) the embedded dense vector representations are informative to identify the similarity and difference among computation pipelines.

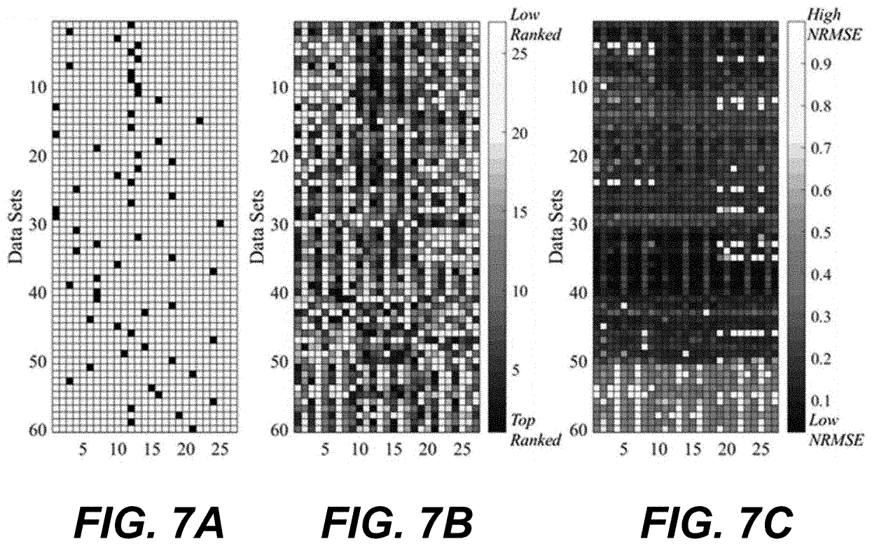

Shown in FIGS. 7A-7C are computation pipelines ranked for 60 data sets. FIG. 7A shows an example of the best computation pipelines associated with the lowest prediction NRMSEs in black blocks. FIG. 7B presents the ranking results, where darker blocks represent a higher rank. FIG. 7C reports the NRMSEs and darker blocks identify lower prediction error.

To interpret the effectiveness of low-rank regularization in the TEMC model, FIG. 7A shows and example of the visualization of the best computation pipelines associated with the lowest prediction NRMSEs. The NRMSEs and heatmaps of ranking results are shown in FIGS. 7A and 7B, respectively. It can be observed from two heatmaps that linear dependencies exist among columns and rows. Note that the distribution of bootstrapped data sets are not identical, which generates similar-but-non-identical covariates by meta data extraction machine. Therefore, the NRMSEs between two bootstrapped data sets (i.e., two adjacent rows in FIG. 7A) may not be identical. The aforementioned linear dependencies represent the low-rank structure of response matrix Y, which can be decomposed into low-rank matrix R and can be captured by nuclear norm regularization. Assuming Y itself to be low-rank can be ambiguous since the underline best computation pipelines for 60 data sets shows no low-rank structures. Therefore, the pure matrix completion model does not perform as well as the TEMC model.

To match the contexts and computation pipelines is critical for providing effective computation services in ICPS in manufacturing. However, exploring all candidate pipelines is inefficient for fast computation services. The recommender system for adaptive computation pipelines integrates a covariates generation machine and a new TEMC model to accurately rank and recommend pipelines for different contexts. A case study in real thermal spray coating, aerosol jet printing, and fused deposition modeling processes showed that the recommender system for adaptive computation pipelines outperforms Matrix Completion, Tensor Regression, and PRIME in both warm-start and cold-start cases in supporting accurate and responsive computation services. The recommender system for adaptive computation pipelines can be applied in other areas as a recommender system to make accurate recommendations in extreme cases.

Additionally, the recommender system for adaptive computation pipelines can be generalized for other types of computation services in ICPS, such as process monitoring, prognosis, diagnosis, and control. In some applications, a distributed recommender system can be used for similar-but-non-identical manufacturing processes in ICPS. In some examples the recommender system 100 can help understand the boundaries and application scope of existing pipelines. The adaptive computation pipelines recommender method can save efforts for both researchers and practitioners in finding the best combination of machine learning and data fusion method options for different manufacturing processes. It can be easily extended to various manufacturing processes with different method options for computation services, and is scalable for different computation systems (e.g., cloud computing, fog computing, and grid computing systems).

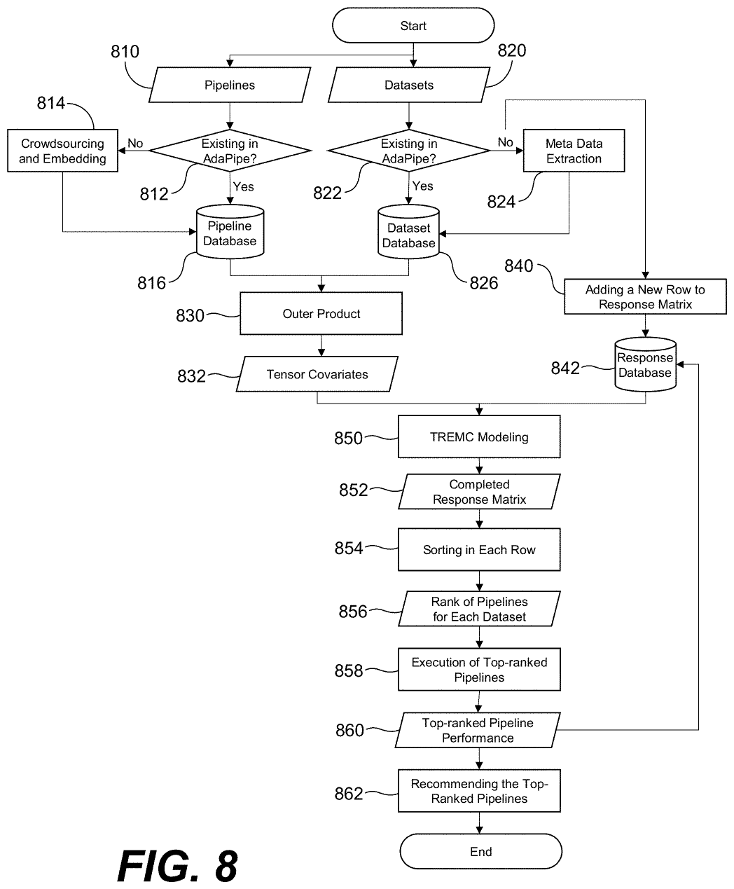

In FIG. 8, an example of the process for the recommender system 100 for adaptive computation pipelines for an industrial cyber-physical system is shown. At 810, the pipelines are identified for the application including the number of method steps and number of method options for each step. At 812, determine whether the pipelines are available in an existing pipeline database. At 814, if pipelines are not available, crowdsource pipeline method options and embed to add to pipeline database. At 816, dense vectors can be generated for the new and/or existing pipelines. At 820, raw data sets are identified. At 822, determine whether the data sets are available in an existing data set database. At 824, if data sets are not available, extract meta data to add to data set database. At 826, meta data vectors can be generated for the new and/or existing data sets. At 830, the outer product of the dense vectors for pipelines and meta data vectors determines the tensor covariates (832). At 840, if a data set is available in an existing data set database, a row is added to a sparse response matrix. At 842, the sparse response matrix is generated for the new and/or existing pipelines and data sets, where each row corresponds to a data set and each column corresponds to a pipeline. At 850, the TEMC model can predict the missing entries based on both the sparse response matrix and the covariates. At 852, a complete matrix is formed. At 854, each row is sorted. At 856, the pipelines in for each data set are ranked. At 858, the top-ranked pipeline execution results are determined. At 860, performance data for the top-ranked pipeline is stored in the response database. At 862, the top-ranked pipeline is recommended for the industrial cyber-physical system for execution.

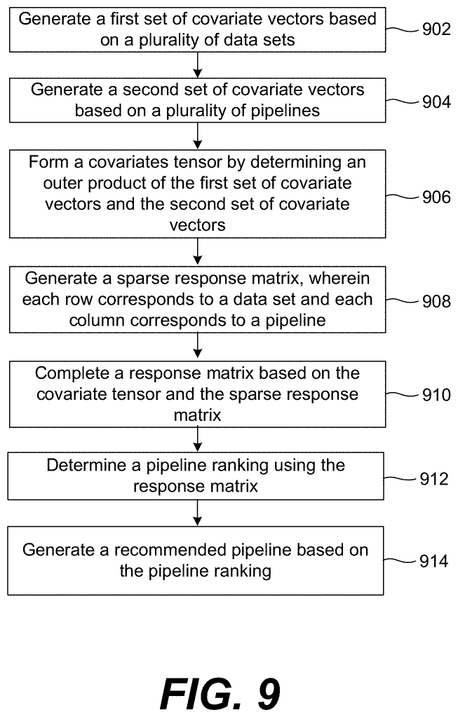

In FIG. 9, an example computer-based method for recommending computation pipelines implemented on the recommender system 100 is shown. At box 902, generate a first set of covariate vectors based on a plurality of data sets. At box 904, generate a second set of covariate vectors based on a plurality of pipelines. At box 906, form a covariates tensor by determining an outer product of the first set of covariate vectors and the second set of covariate vectors. At box 908, generate a sparse response matrix, wherein each row corresponds to a data set and each column corresponds to a pipeline. At box 910, complete a response matrix based on the covariate tensor and the sparse response matrix. At box 912, determine a pipeline ranking using the response matrix. At box 914, generate a recommended pipeline based on the pipeline ranking. Any recited method can be carried out in the order of events recited or in any other order that is logically possible, and certain features and elements can be added or omitted.

Various embodiments of a recommender system for adaptive computation pipelines and method are described. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a recommender system for adaptive computation pipelines in cyber-manufacturing computational services. The system also includes a computing device that may include at least one hardware processor. The system also includes program instructions executable in the computing device that, when executed by the computing device, cause the computing device to: generate a first set of covariate vectors based on a plurality of data sets; generate a second set of covariate vectors based on a plurality of pipelines; form a covariates tensor by determining an outer product of the first set of covariate vectors and the second set of covariate vectors; generate a sparse response matrix, wherein each row corresponds to a data set and each column corresponds to a pipeline; complete a response matrix based on the covariate tensor and the sparse response matrix; determine a pipeline ranking using the response matrix; and generate a recommended pipeline based on the pipeline ranking. Other embodiments of this aspect include corresponding computer systems, apparatus, and computer programs recorded on one or more computer storage devices, each configured to perform the actions of the methods.

The embodiments described herein can be implemented in hardware, software, or a combination of hardware and software. If embodied in software, the functions, steps, and elements can be implemented as a module or set of code that includes program instructions to implement the specified logical functions. The program instructions can be embodied in the form of, for example, source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

The embodiments can be implemented by at least one processing circuit or device and at least one memory circuit or device. Such a processing circuit can include, for example, one or more processors and one or more storage or memory devices coupled to a local interface. The local interface can include, for example, a data bus with an accompanying address/control bus or any other suitable bus structure. The memory circuit can store data or components that are executable by the processing circuit.

If embodied as hardware, the functions, steps, and elements can be implemented as a circuit or state machine that employs any suitable hardware technology. The hardware technology can include, for example, one or more microprocessors, discrete logic circuits having logic gates for implementing various logic functions upon an application of one or more data signals, application specific integrated circuits (ASICs) having appropriate logic gates, and/or programmable logic devices (e.g., field-programmable gate array (FPGAs), and complex programmable logic devices (CPLDs)).

Also, one or more of the components described herein that include software or program instructions can be embodied in any non-transitory computer-readable medium for use by or in connection with an instruction execution system such as, a processor in a computer system or other system. The computer-readable medium can contain, store, and/or maintain the software or program instructions for use by or in connection with the instruction execution system.

A computer-readable medium can include a physical media, such as, magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in one computing device or by using multiple computing devices.

Further, any functions, steps, and elements described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices. Additionally, terms such as “application,” “service,” “system,” “engine,” “module,” and so on can be used interchangeably and are not intended to be limiting.

The above-described examples of the present disclosure are merely possible examples of implementations set forth for a clear understanding of the principles of the disclosure. Many variations and modifications can be made without departing substantially from the spirit and principles of the disclosure. All such modifications and variations are intended to be included herein within the scope of this disclosure and protected by the following claims.

Therefore, the following is claimed:

1. A recommender system for adaptive computation pipelines, the system comprising:
a computing device comprising at least one hardware processor; and
a memory device that stores program instructions executable in the computing device that, when executed by the computing device, cause the computing device to:
generate a first set of covariate vectors based on a plurality of data sets;
generate a second set of covariate vectors based on a plurality of pipelines;
form a covariates tensor by determining an outer product of the first set of covariate vectors and the second set of covariate vectors;
generate a sparse response matrix, wherein each row corresponds to a data set and each column corresponds to a pipeline;
complete a response matrix based on the covariate tensor and the sparse response matrix;
determine a pipeline ranking using the response matrix; and
generate a recommended pipeline based on the pipeline ranking.

2. The system of claim 1, wherein, to generate the first set of covariate vectors, the program instructions further cause the computing device to extract a vector of summary statistics from the plurality of data sets.

3. The system of claim 1, wherein, to generate the second set of covariate vectors, the program instructions further cause the computing device to create an informative dense vector in real space by concatenating an embedded vector in a pre-defined order for the plurality of pipelines.

4. The system of claim 3, wherein the embedded vector comprises a method option description extracted by a neural network.

5. The system of claim 4, wherein the method option description is obtained using a web crawler configured to collect and parse websites and documents as a corpus of text.

6. The system of claim 1, wherein, to complete the response matrix, the program instructions further cause the computing device to execute a tensor regression-based extended matrix completion model.

7. The system of claim 6, wherein the tensor regression-based extended matrix completion model receives the covariates tensor and the sparse response matrix as inputs.

8. The system of claim 1, wherein each pipeline of the plurality of pipelines share the same steps for a certain type of computation service.

9. The system of claim 1, wherein meta data vectors for the first set of covariate vectors are generated using an embedding neural network.

10. The system of claim 1, wherein meta data vectors for the first set of covariate vectors are generated from existing and new data sets.

11. The system of claim 1, wherein the sparse response matrix has a linear relationship with a low-rank matrix and covariates.

12. The system of claim 1, wherein the sparse response matrix is extracted assuming it is missing at least one row, at least one column, or at least one row and at least one column.

13. The system of claim 1, wherein the sparse response matrix is extracted assuming arbitrary missing entries.

14. A computer-based method for recommending adaptive computation pipelines, the method comprising:
generating a first set of covariate vectors based on a plurality of data sets;
generating a second set of covariate vectors based on a plurality of pipelines;
forming a covariates tensor by determining an outer product of the first set of covariate vectors and the second set of covariate vectors;
generating a sparse response matrix, wherein each row corresponds to a data set and each column corresponds to a pipeline;
completing a response matrix based on the covariate tensor and the sparse response matrix;
determining a pipeline ranking using the response matrix; and
generating a recommended pipeline based on the pipeline ranking.

15. The method of claim 14, wherein completing the response matrix comprises executing a tensor regression-based extended matrix completion model.

16. The method of claim 15, wherein the tensor regression-based extended matrix completion model receives the covariates tensor and the sparse response matrix as input.

17. The method of claim 14, wherein the plurality of data sets comprise existing data sets, new data sets, or a combination of both.

18. The method of claim 14, wherein the plurality of pipelines comprise existing pipelines, new pipelines, or a combination of both.

19. The method of claim 14, wherein determining a pipeline ranking using the response matrix comprises sorting each row of the response matrix to rank the pipelines.

20. A non-transitory computer-readable medium embodying program instructions executable in a computing device that, when executed by the computing device, cause the computing device to:
generate a first set of covariate vectors based on a plurality of data sets;
generate a second set of covariate vectors based on a plurality of pipelines;
form a covariates tensor by determining an outer product of the first set of covariate vectors and the second set of covariate vectors;
generate a sparse response matrix, wherein each row corresponds to a data set and each column corresponds to a pipeline;
complete a response matrix based on the covariate tensor and the sparse response matrix;
determine a pipeline ranking using the response matrix; and
generate a recommended pipeline based on the pipeline ranking.
